(19) United States
(12) Patent Application Publication
(10) Pub. No.: US 2013/0270960 A1
(43) Pub. Date: Oct. 17, 2013

(54) ELECTRIC MACHINE STATIONARY ASSEMBLY AND METHODS OF ASSEMBLING THE SAME

(71) Applicants: Jason Jon Kreidler, Sheboygan Falls, WI (US); William J. Conway, Wausau, WI (US); Wesley K. Anderson, Cedarburg, WI (US)

(72) Inventors: Jason Jon Kreidler, Sheboygan Falls, WI (US); William J. Conway, Wausau, WI (US); Wesley K. Anderson, Cedarburg, WI (US)

(73) Assignee: RBC Manufacturing Corporation, Wausau, WI (US)

(21) Appl. No.: 13/446,818

(22) Filed: Apr. 13, 2012

(51) Int. Cl. H02K 1/18; H02K 15/00

(52) U.S. Cl. 310/216.009; 29/596

(57) ABSTRACT

An electric machine stationary assembly is described. The stationary assembly includes a plurality of stacked laminations each comprising a first end and a second end. The stationary assembly also includes a mechanically deformable first fastening feature positioned at the first end of each lamination. The stationary assembly also includes a second fastening feature positioned at the second end of each lamination and configured to cooperate with the first fastening feature to couple the first end to the second end.

### BACKGROUND OF THE INVENTION

The field of the invention relates generally to electric machines, and more specifically, to a stationary assembly for use in an electric machine and methods of assembling the same.

A stationary assembly, also referred to as a stator, includes a stator core and windings positioned around portions of the stator core. A known method of manufacturing a stationary assembly includes stacking a plurality of laminations and rolling the stack to form a round stator. The laminations are stamped from a sheet of stock material and stacked to form a substantially linear array of stator sections and connecting members. The substantially linear array includes a first end and a second end. Windings may be wound on the stator sections while the laminations are in the linear orientation. Once the windings are positioned on the stator sections, the stack is formed into a second shape. To form the stack into the second shape, the stack is rolled around a central axis and the first end is coupled to the second end. The second shape is the substantially round shape of a stator. Typically, the second shape is maintained by welding the first end to the second end. However, welding requires heat, which is not desirable near the windings and insulation that surrounds the wires that form the windings. Furthermore, welding may also adversely affect electrical characteristics of the stator core.

### BRIEF DESCRIPTION OF THE INVENTION

In one aspect, an electric machine stationary assembly is provided. The stationary assembly includes a plurality of stacked laminations each comprising a first end and a second end. The stationary assembly also includes a mechanically deformable first fastening feature positioned at the first end of each lamination. The stationary assembly also includes a second fastening feature positioned at the second end of each lamination and configured to cooperate with the first fastening feature to couple the first end to the second end.

In another aspect, a method for forming an electric machine stationary assembly from a plurality of laminations is provided. The method includes providing a sheet stock material and stamping a plurality of laminations from the sheet of stock material. Each lamination includes a plurality of stator sections oriented in a first relative orientation having a first end and a second end. The laminations each include a mechanically deformable first fastening feature positioned at the first end and a second fastening feature positioned at the second end. The method also includes stacking the laminations to form a stack of laminations and winding at least one winding around a portion of the stator sections while the stack of laminations is in the first orientation. The method also includes forming the stack of laminations into a second relative orientation of stator sections and mechanically deforming the first fastening feature to couple the first end to the second end and maintain the stack of laminations in the second relative orientation.

In yet another aspect, an electric machine is provided. The electric machine includes a machine housing and a rotatable assembly disposed at least partially within the machine housing. The electric machine also includes a stationary assembly disposed at least partially within the machine housing. The rotatable assembly is configured to rotate with respect to the stationary assembly. The stationary assembly includes a plurality of stacked laminations each comprising a first end and a second end, a mechanically deformable first fastening feature positioned at the first end of each lamination, and a second fastening feature positioned at the second end of each lamination and configured to cooperate with the first fastening feature to couple the first end to the second end.

### BRIEF DESCRIPTION OF THE DRAWINGS

FIG. 1 is a perspective cut-away view of an exemplary electric machine that includes a stationary assembly.

FIG. 2 is a top view of an exemplary stator lamination in a first orientation that may be included within the electric machine shown in FIG. 1.

FIG. 3 is a top view of the stator lamination shown in FIG. 2 in a second orientation.

FIG. 4 is an expanded top view of a first stator section included in the stator lamination shown in FIGS. 2 and 3.

FIG. 5 is an expanded top view of a second stator section included in the stator lamination shown in FIGS. 2 and 3.

FIG. 6 is a perspective view of the first stator section shown in FIG. 4.

FIG. 7 is a perspective view of the second stator section shown in FIG. 5.

FIG. 8 is a flow chart of an exemplary method for assembling a stationary assembly that may be included within the electric machine shown in FIG. 1.

### DETAILED DESCRIPTION OF THE INVENTION

The methods, systems, and apparatus described herein facilitate efficient and economical manufacturing of an electric machine, for example, an electric motor or an electric generator. As described herein, the electric machine includes a stationary assembly manufactured from a plurality of laminations. In the exemplary embodiment, each of the laminations includes at least one fastening feature used to maintain the stator in a predefined shape. For example, the at least one fastening feature may include a first mechanically deformable fastening feature configured to cooperate with a corresponding second fastening feature to maintain the stator in the predefined shape.

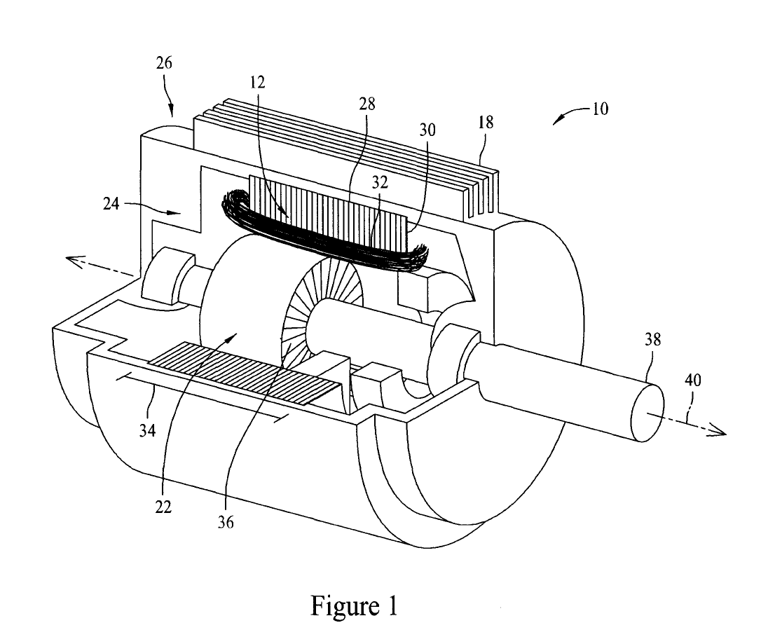

FIG. 1 is a perspective cut-away view of an exemplary electric machine 10 that includes a stationary assembly 12. Electric machine 10 also includes a machine assembly housing 18 and a rotatable assembly 22. Machine assembly housing 18 defines an interior 24 and an exterior 26 of machine 10 and is configured to at least partially enclose and protect stationary assembly 12 and rotatable assembly 22. Stationary assembly 12 includes a stator core 28, which includes a plurality of stator teeth 30 and a plurality of windings 32 wound around stator teeth 30. In an exemplary embodiment, stationary assembly 12 is a three phase salient pole stator assembly, stator core 28 is formed from a stack of laminations made of a highly magnetically permeable material, and windings 32 are wound on stator core 28 in a manner known to those of ordinary skill in the art. Laminations are stacked such that stator core 28 reaches a predefined length 34. In the exemplary embodiment, the plurality of laminations that form stator core 28 may be either interlocked or loose laminations. In an alternative embodiment, stator core 28 is a solid core. For example, stator core 28 may be formed from a soft magnetic composite (SMC) material, a soft magnetic alloy (SMA) material, and/or a powdered ferrite material using a sintering process.

In one embodiment, rotatable assembly 22 includes a permanent magnet rotor core 36 and a shaft 38 and is configured to rotate around an axis of rotation 40. In the exemplary embodiment, rotor core 36 is formed from a stack of laminations made of a magnetically permeable material and is substantially received in a central bore of stator core 28. While FIG. 1 is an illustration of a three phase electric motor, the methods and apparatus described herein may be included within machines having any number of phases, including single phase and multiple phase electric machines.

In the exemplary embodiment, electric machine 10 is coupled to a fan (not shown) for moving air through an air handling system, for blowing air over cooling coils, and/or for driving a compressor within an air conditioning/refrigeration system. More specifically, machine 10 may be used in air moving applications used in the heating, ventilation, and air conditioning (HVAC) industry, for example, in residential applications using ⅓ horsepower (hp) to 1 hp motors and/or in commercial and industrial applications and hermetic compressor motors used in air conditioning applications using higher horsepower motors, for example, but not limited to, a 7.5 hp motor. Although described herein in the context of an air handling system, electric machine 10 may engage any suitable work component and be configured to drive such a work component. Alternatively, electric machine 10 may be coupled to a power conversion component, for example, an engine, a wind turbine rotor, and/or any other component configured to rotate rotatable assembly 22 to generate electricity using electric machine 10.

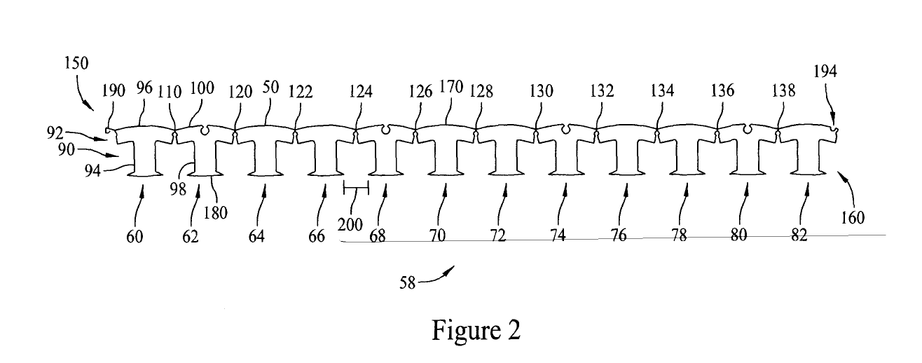

FIG. 2 is a top view of an exemplary stator lamination 50 in a first orientation that may be included within electric machine 10 (shown in FIG. 1). In the exemplary embodiment, stator lamination 50 includes a plurality of stator sections 58, for example, a first stator section 60, a second stator section 62, a third stator section 64, a fourth stator section 66, a fifth stator section 68, a sixth stator section 70, a seventh stator section 72, an eighth stator section 74, a ninth stator section 76, a tenth stator section 78, an eleventh stator section 80, and an n^{th} stator section 82. Although illustrated as including twelve stator sections, stator lamination 50 may include any suitable number of sections that allows electric machine 10 to function as described herein. As illustrated, tooth sections 60, 62, 64, 66, 68, 70, 72, 74, 76, 78, 80, and 82 are aligned in a substantially linear orientation.

In the exemplary embodiment, stator sections 58 each include a stator tooth 90 and a body 92. In the exemplary embodiment, stator tooth 90 extends from body 92. For example, first stator section 60 includes a first stator tooth 94 that extends from a first body 96 and second stator section 62 includes a second stator tooth 98 that extends from a second body 100. In the exemplary embodiment, stator lamination 50 further includes a first connecting member 110 that couples first body 96 to second body 100. Furthermore, stator lamination 50 includes a second connecting member 120, a third connecting member 122, a fourth connecting member 124, a fifth connecting member 126, a sixth connecting member 128, a seventh connecting member 130, an eighth connecting member 132, a ninth connecting member 134, a tenth connecting member 136, and an eleventh connecting member 138 that each couples a stator section to an adjacent stator section.

Stator lamination 50 is punched from a sheet of stock material and includes a first end 150 and a second end 160. Stator lamination 50 also includes a first edge 170 and a second edge 180. In the exemplary embodiment, stator lamination 50 includes a first fastening feature 190 that extends from first end 150. In the exemplary embodiment, first fastening feature 190 is mechanically deformable, that is, it can be moved from a first position to a second position when a sufficient force is applied thereto. Furthermore, in the exemplary embodiment, first fastening feature 190 is a latch.

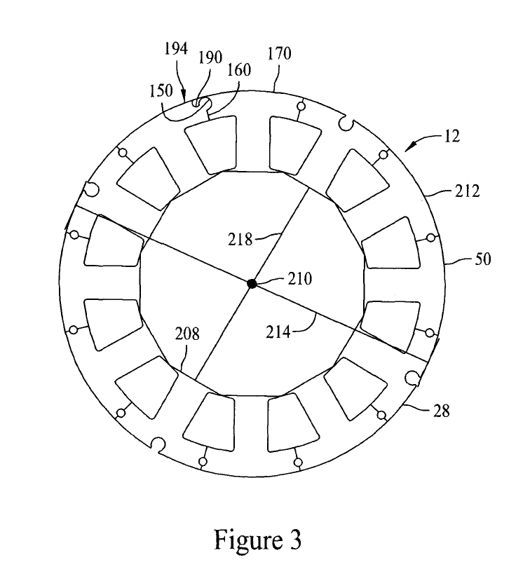

In the exemplary embodiment, stator lamination 50 also includes a second fastening feature 194 included at second end 160. For example, second fastening feature 194 may include an opening configured to cooperate with first fastening feature 190 to couple first end 150 to second end 160 (see FIG. 3). The opening may also be referred to as a notch, a groove, or any other suitable member operable to cooperate with first fastening feature 190 to maintain stator lamination in a predetermined orientation.

FIG. 3 is a top view of stator lamination 50 in a second orientation. More specifically, the second orientation is substantially circular. In the exemplary embodiment, stator laminations 50 are stacked such that stator core 28 reaches predefined length 34 (shown in FIG. 1). Windings 32 (shown in FIG. 1) are wound on stator core 28 while the stack of stator laminations 50 is in the substantially linear orientation shown in FIG. 2. A distance 200 (shown in FIG. 2) between stator teeth is greater when the stack of stator laminations 50 is in the linear orientation than when the stack of stator laminations 50 is in the substantially circular orientation. The greater distance between stator teeth eases winding of windings 32 around the teeth.

In the exemplary embodiment, the stack of stator laminations 50 is formed into the second orientation wherein an inner surface 208 of each stator tooth is substantially equidistant from a central axis 210. When electric machine 10 is assembled, central axis 210 corresponds to axis of rotation 40 (shown in FIG. 1) of rotatable assembly 22 (shown in FIG. 1). In the second orientation, first edge 170 of stator laminations 50 defines an outer surface 212 of stator core 28 having an outer diameter 214. Second edge 180 defines inner surface 208 having an inner diameter 218. Furthermore, in the second orientation, first end 150 is coupled to second end 160 of each stator lamination 50. Moreover, in the illustrated embodiment, first fastening feature 190 has been mechanically deformed into a second position (i.e., a locked position) such that a portion of first fastening feature 190 extends at least partially into second fastening feature 194.

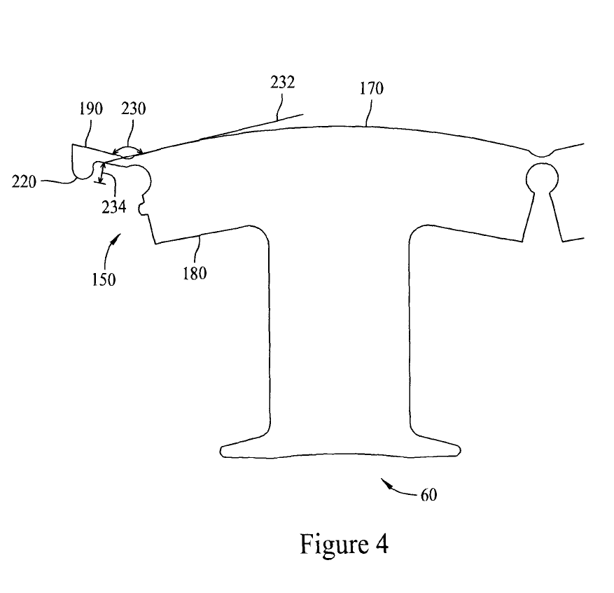

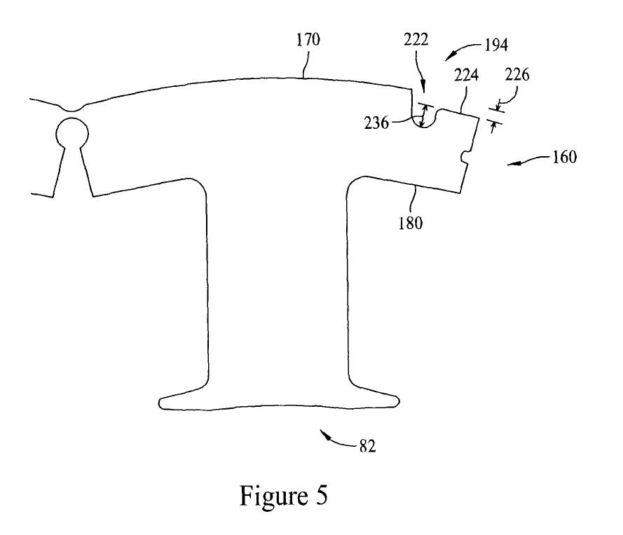

FIG. 4 is an expanded top view of first stator section 60. FIG. 5 is an expanded top view of n^{th} stator section 82. In the illustrative embodiment, first fastening feature 190 and second fastening feature 194 are positioned along first edge 170 of stator lamination 50. In an alternative embodiment, first fastening feature 190 and second fastening feature 194 may be positioned along second edge 180 or at any other position on stator lamination 50 that allows first and second fastening features 190 and 194 to couple first end 150 to second end 160 and maintain stator core 28 in the circular orientation.

In the exemplary embodiment, first fastening feature 190 includes a tab 220 extending from stator lamination 50 and second fastening feature 194 includes an opening 222 defined within stator lamination 50 and a recessed portion 224. In the exemplary embodiment, opening 222 has a rounded shape. However, opening 222 may be any suitable shape, corresponding to the shape of tab 220, that allows stator core 28 to function as described herein. Tab 220 is a projection or a protruding member configured to extend into opening 222 and to secure first end 150 to second end 160. In the exemplary embodiment, recessed portion 224 is a predefined distance 226 closer to central axis 210 than first edge 170. Tab 220 is configured to fit at least partially within opening 222. As illustrated in FIG. 4, first fastening feature 190 is in a first position (i.e., an open position). In the first position, an angle 230 between first fastening feature 190 and a tangent 232 along first edge 170 is small enough that when stator lamination 50 is formed into the second orientation (i.e., the circular orientation) second edge 180 of tab 220 is a greater distance from central axis 210 than recessed portion 224. In other words, in the first position, first fastening feature 190 is configured to allow stator lamination 50 to be formed into the second orientation (i.e., not interfere with rolling stator lamination 50 into the second orientation). When stator lamination 50 is formed into the second orientation, tab 220 passes over recessed portion 224 to a position where tab 220 is aligned with opening 222. A length 234 of tab 220, and a corresponding depth 236 of opening 222, is predetermined such that stator lamination 50 is maintained in the second orientation when first fastening feature 190 is in the second position.

First fastening feature 190 is configured to be mechanically deformed in order to secure first end 150 to second end 160. For example, pressure may be applied to first edge 170 of first fastening feature 190 in a radial direction, toward central axis 210. The applied pressure causes first fastening feature 190 to transition from the first position (shown in FIG. 4) to the second position (shown in FIG. 3). Moreover, the applied pressure causes at least a portion of first fastening feature 190 to interact with second fastening feature 194 to secure first end 150 to second end 160.

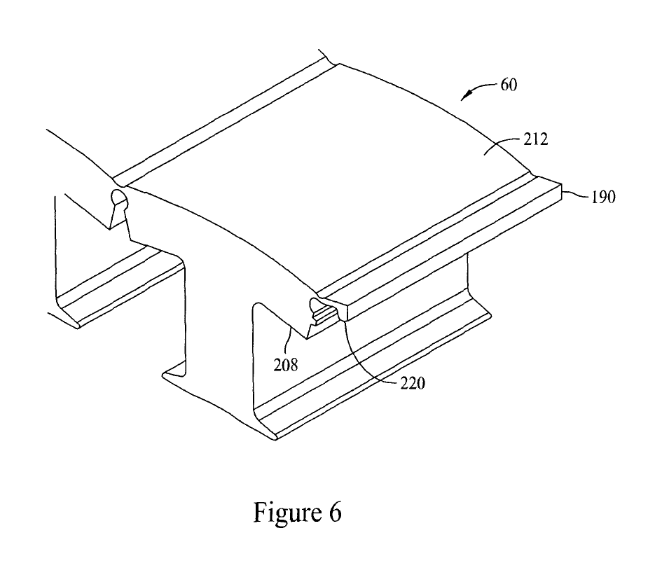

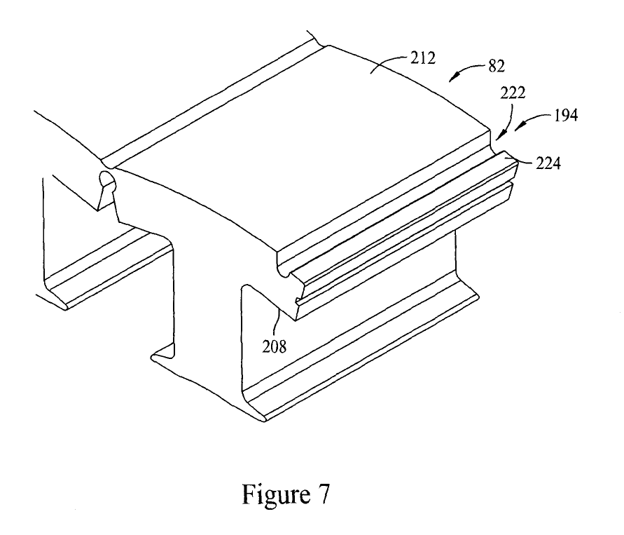

FIG. 6 is a perspective view of first stator section 60. FIG. 7 is a perspective view of n^{th} stator section 82. Stator sections 60 and 82 are illustrated as being solid in FIGS. 6 and 7 for simplicity. Features shown and described with respect to FIGS. 4 and 5 are identified with identical reference numbers in FIGS. 6 and 7.

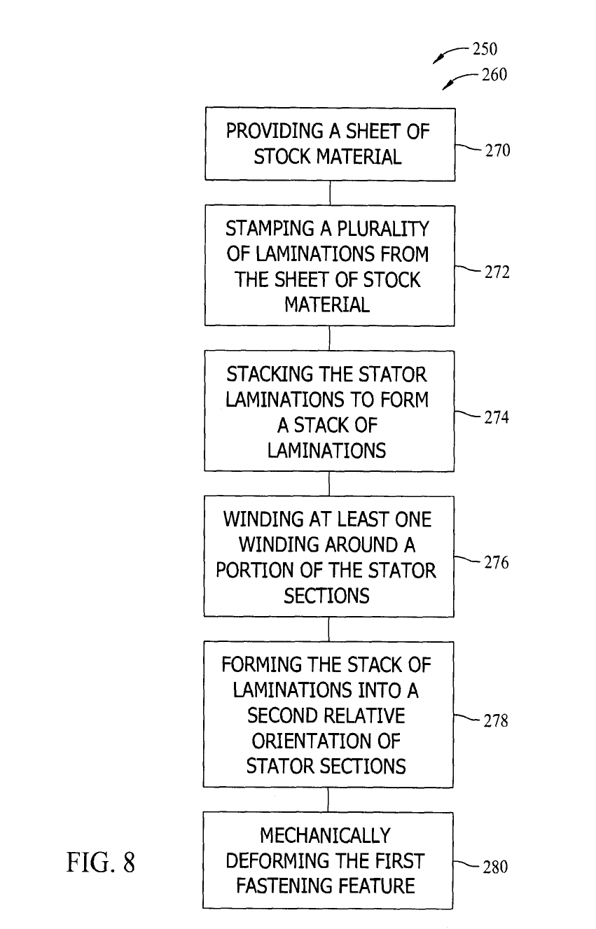

FIG. 8 is a flow chart 250 of an exemplary method 260 for assembling a stationary assembly for an electric machine, for example, stationary assembly 12 (shown in FIG. 1). As described above, stationary assembly 12 includes stator core 28 and windings 32. In the exemplary embodiment, method 260 includes providing 270 a sheet stock material from which stator core 28 will be manufactured.

In the exemplary embodiment, method 260 also includes stamping 272 a plurality of laminations, for example, stator laminations 50 (shown in FIG. 2), from the sheet of stock material. Each stator lamination 50 includes a plurality of stator sections, for example, plurality of stator sections 58 (shown in FIG. 2), oriented in a first relative orientation having a first end and a second end, for example, first end 150 and second end 160 (both shown in FIG. 2). Furthermore, each stator lamination 50 includes a mechanically deformable first fastening feature, for example, first fastener feature 190 (shown in FIG. 2), positioned at first end 150 and a second fastening feature, for example, second fastening feature 194 (shown in FIG. 2), positioned at second end 160.

In the exemplary embodiment, method 260 also includes stacking 274 the stator laminations 50 to form a stack of laminations. In the first relative orientation, stator sections 58 are in a substantially linear orientation. In the exemplary embodiment, method 260 also includes winding 276 at least one winding, for example, windings 32, around a portion of stator sections 58 while the stack of laminations is in the first orientation. In an alternative embodiment, the windings are wound 276 around a portion of stator sections 58 after the stack of laminations is formed into a second relative orientation of stator sections 58 or after first fastening feature 190 is deformed to couple first end 150 to second end 160.

Method 260 further includes forming 278 the stack of laminations into a second relative orientation of stator sections 58. For example, the stack of laminations is formed 278 into a substantially circular orientation defined around a central axis, for example, central axis 210 (shown in FIG. 3), wherein first end 150 is adjacent second end 160.

In the exemplary embodiment, method 260 also includes mechanically deforming 280 first fastening feature 190 to couple first end 150 to second end 160 and maintain the stack of laminations in the second relative orientation. For example, first fastening feature 190 may be mechanically deformed 280 such that a portion of first fastening feature 190 extends into a portion of second fastening feature 194.

In the exemplary embodiment, stamping 272 includes stamping laminations that include first fastening feature 190 and second fastening feature 194 positioned along a first edge, for example, first edge 170 (shown in FIG. 3), of laminations 50. As described above, first edge 170 defines an outer surface, for example, outer surface 212 (shown in FIG. 3), of stationary assembly 12 when formed into the substantially circular orientation. In the exemplary embodiment, mechanically deforming 280 first fastening feature 190 includes applying a force to first fastening feature 190 in a direction toward central axis 210.

In an alternative embodiment, stamping 272 includes stamping laminations that include first fastening feature 190 and second fastening feature 194 positioned along a second edge, for example, second edge 180 (shown in FIG. 3) of the laminations 50. As described above, second edge 180 defines an inner surface, for example, inner surface 208 (shown in FIG. 3) of stationary assembly 12 when formed into the substantially circular orientation. In the alternative embodiment, mechanically deforming 280 first fastening feature 190 includes applying a force to first fastening feature 190 in a direction away from central axis 210.

Described herein are exemplary stationary assemblies for use in an electric machine and exemplary methods of assembling such assemblies. More specifically, the methods and apparatus described herein facilitate maintaining a stator core in a second, circular orientation, when the stator core is manufactured from laminations initially having a substantially linear orientation. In the exemplary embodiment, each of the laminations includes at least one fastening feature that maintains the stator in the second, circular orientation. For example, the at least one fastening feature may include a first mechanically deformable fastening feature configured to cooperate with a corresponding second fastening feature to maintain the stator in the predefined shape. The fastening features described herein facilitate maintaining the circular orientation without the use of welding. By avoiding welding, heat related damage to the stator laminations and/or the windings is prevented.

The methods and apparatus described herein facilitate efficient and economical manufacture and operation of an electric machine. Exemplary embodiments of methods and apparatus are described and/or illustrated herein in detail. The methods and apparatus are not limited to the specific embodiments described herein, but rather, components of each apparatus, as well as steps of each method, may be utilized independently and separately from other components and steps described herein. Each component, and each method step, can also be used in combination with other components and/or method steps.

When introducing elements/components/etc. of the methods and apparatus described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A stationary assembly for an electric machine, said assembly comprising:
a plurality of stacked laminations comprising a first lamination having a first end and a second end;
a mechanically deformable first fastening feature positioned at said first end of said first lamination; and
a second fastening feature positioned at said second end of said first lamination and configured to cooperate with said first fastening feature to couple said first end to said second end.

2. An assembly in accordance with claim 1, wherein each said lamination is punched from a sheet of stock material, stacked to form a stack of laminations having a substantially linear orientation, and formed into a substantially circular orientation defined around a central axis wherein said first end is adjacent said second end.

3. An assembly in accordance with claim 2, wherein said mechanically deformable first fastening feature and said second fastening feature are configured to maintain said plurality of stacked laminations in the substantially circular orientation.

4. An assembly in accordance with claim 2, wherein said first and second fastening features are positioned along a first edge of said first lamination, wherein said first edge corresponds to an outer surface of said stator when formed into the substantially circular orientation, and wherein said first fastening feature is configured to be deformed by a force applied to said first fastening feature in a direction toward the central axis.

5. An assembly in accordance with claim 2, wherein said first and second fastening features are positioned along a second edge of said first lamination, wherein said second edge corresponds to an inner surface of said stator when formed into the substantially circular orientation, and wherein said first fastening feature is configured to be deformed by a force applied to said first fastening feature in a direction away from the central axis.

6. An assembly in accordance with claim 1, wherein said mechanically deformable first fastening feature comprises a latch.

7. An assembly in accordance with claim 1, wherein said second fastening feature comprises an opening configured to receive at least a portion of said mechanically deformable first fastening feature.

8. A method for forming a stationary assembly for an electric machine from a plurality of laminations, said method comprising:
providing a sheet of stock material;
stamping a plurality of laminations from the sheet, each lamination comprising a plurality of stator sections oriented in a first relative orientation having a first end and a second end, wherein the laminations each include a mechanically deformable first fastening feature positioned at the first end and a second fastening feature positioned at the second end;
stacking the laminations to form a stack of laminations;
forming the stack of laminations into a second relative orientation of stator sections; and
mechanically deforming the first fastening feature to couple the first end to the second end and maintain the stack of laminations in the second relative orientation.

9. A method in accordance with claim 8, wherein forming the stack of laminations into the second relative orientation of stator sections comprises forming the stack of laminations into a substantially circular orientation defined around a central axis wherein the first end is adjacent the second end.

10. A method in accordance with claim 9, wherein stamping the plurality of laminations from the sheet includes stamping a plurality of laminations that include the first and second fastening features positioned along a first edge of the laminations, wherein the first edge corresponds to an outer surface of the stack of laminations when formed into the substantially circular orientation.

11. A method in accordance with claim 10, wherein mechanically deforming the first fastening feature comprises applying a force to the first fastening feature in a direction toward the central axis.

12. A method in accordance with claim 8, wherein stamping the plurality of laminations from the sheet includes stamping a plurality of laminations that include the first and second fastening features positioned along a second edge of the laminations, wherein the second edge corresponds to an inner surface of the stack of laminations when formed into the substantially circular orientation.

13. A method in accordance with claim 12, wherein mechanically deforming the first fastening feature comprises applying a force to the first fastening feature in a direction away from the central axis.

14. A method in accordance with claim 8, wherein mechanically deforming the first fastening feature comprises deforming the first fastening feature such that a portion of the first fastening feature extends into a portion of the second fastening feature.

15. A method in accordance with claim 8, further comprising winding at least one winding around a portion of the stator sections while the stack of laminations is in the first orientation.

16. An electric machine comprising:
a machine housing;
a rotatable assembly disposed at least partially within said machine housing; and
a stationary assembly disposed at least partially within said machine housing, said rotatable assembly configured to rotate with respect to said stationary assembly, said stationary assembly comprising:
a plurality of stacked laminations each comprising a first end and a second end;
a mechanically deformable first fastening feature positioned at said first end of each lamination; and
a second fastening feature positioned at said second end of each lamination and configured to cooperate with said first fastening feature to couple said first end to said second end.

17. An electric machine in accordance with claim 16, wherein each of said plurality of stacked laminations is punched from a sheet of stock material, stacked to form a stack of laminations having a substantially linear orientation, and formed into a substantially circular orientation defined around a central axis wherein said first end is adjacent said second end.

18. An electric machine in accordance with claim 17, wherein said mechanically deformable first fastening feature and said second fastening feature are configured to maintain said plurality of stacked laminations in the substantially circular orientation.

19. An electric machine in accordance with claim 17, wherein said first and second fastening features are positioned along at least one of:
a first edge of said laminations that corresponds to an outer surface of said stationary assembly when formed into the substantially circular orientation, and wherein said first fastening feature is configured to be deformed by a force applied to said first fastening feature in a direction toward the central axis; and
a second edge of said laminations that corresponds to an inner surface of said stationary assembly when formed into the substantially circular orientation, and wherein said first fastening feature is configured to be deformed by a force applied to said first fastening feature in a direction away from the central axis.

20. An electric machine in accordance with claim 16, wherein said mechanically deformable first fastening feature comprises a latch, and wherein said second fastening feature comprises an opening configured to receive at least a portion of said latch.
